(19) United States
(12) Patent Application Publication
(10) Pub. No.: US 2008/0185862 A1
(43) Pub. Date: Aug. 7, 2008

(54) COLLAPSIBLE STORAGE SYSTEM FOR VEHICLE STORAGE AREA

(75) Inventors: Christopher Francis TARRANT, Truro (CA); Robin MUNROE, Halifax (CA); Gerry PIKE, Ardoise (CA); Ian SAUNDERS, Lawrencetown (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(73) Assignee: EXCO AUTOMOTIVE SOLUTIONS CANADA, INC., Dartmouth (CA)

(21) Appl. No.: 12/026,954

(22) Filed: Feb. 6, 2008

Related U.S. Application Data
(60) Provisional application No. 60/888,368, filed on Feb. 6, 2007.

(51) Int. Cl. B60R 9/00

(52) U.S. Cl. 296/37.6

(57) ABSTRACT

There is provided a collapsible storage system for a storage area of a vehicle comprising a pair of panels; a flexible sheet, connecting said pair of panels; wherein said panels can be moved between open and collapsed positions by extending and folding the sheet respectively.

### CROSS-REFERENCE TO RELATED APPLICATIONS

This application claims the benefit of U.S. Provisional Application No. 60/888,368, filed Feb. 6, 2007, which is incorporated herein by reference.

### FIELD OF THE INVENTION

This invention relates to storage solutions in vehicles, and more particularly, to a collapsible storage system for a vehicle storage area, such as a pickup truck bed.

### BACKGROUND OF THE INVENTION

In the past, very few cargo management or storage options have been offered to pickup truck owners. The primary of which are large steel or aluminum tool boxes that are hard mounted to the vehicle's bed close to the cab. While this system does work to create a lockable storage area for the vehicle, it does have drawbacks.

Firstly, the tool boxes requires a significant amount of area in the vehicle's bed and is not easily removed for full optimization of the vehicle's cargo space. Secondly, since the tool box can not be easily moved and is located close to the truck cab at all times, accessing the storage, or tool box can be very awkward for smaller items such as grocery bags.

Therefore, a novel collapsible storage system for a storage area of a vehicle, such as a pickup truck bed is provided.

### SUMMARY OF THE INVENTION

The present invention is directed at a collapsible storage system for a vehicle storage area, such as a pickup truck bed. In one embodiment, the system can be placed at any location within the truck bed and spans the width of the bed. In another embodiment, in an open, or storage, position, the system expands perpendicular to the walls of the truck bed to provide a storage system and in a collapsed position is folded so that it does not take up room in the truck bed.

In another embodiment, the system expands parallel to the walls of the truck bed.

In a further aspect of the invention, there is provided a collapsible storage system for a storage area of a vehicle comprising a pair of panels; a flexible sheet, connecting said pair of panels; wherein said panels can be moved between open and collapsed positions by extending and folding the sheet respectively.

In another aspect, there is provided a collapsible storage system for a storage area of a vehicle comprising a pair of panels; a foldable sheet, connecting said pair of panels; wherein said panels can be moved between open and collapsed positions by extending and folding the sheet respectively.

### BRIEF DESCRIPTION OF THE DRAWINGS

Embodiments of the present invention will now be described, by way of example only, with reference to the attached Figures, wherein:

FIG. 1 is a schematic diagram of a collapsible storage system in an open position in a front of a truck bed;

FIG. 2 is a schematic diagram of the collapsible storage system in the open position in a rear of the truck bed;

FIG. 3 is a schematic diagram of the collapsible storage system in the open position;

FIG. 4 is an exploded view of a rail integration apparatus;

FIG. 5 is a schematic diagram of the collapsible storage system in FIG. 1, in a collapsed position in the front of the truck bed;

FIG. 6 is a schematic diagram of the collapsible storage system in the collapsed position;

FIG. 7 is a schematic diagram of the system in the open position with one cover rotated 90 degrees;

FIG. 8 is a schematic diagram of the system in the open position with an attachment system designed for vehicles without an incorporated rail system;

FIGS. 9a to 9c are perspective views of further embodiments of a collapsible storage system;

FIGS. 10a and 10b are perspective views of a further embodiment of a collapsible storage system;

FIGS. 11a and 11b are perspective views of yet a further embodiment of a collapsible storage system;

FIGS. 12a and 12b are perspective views of yet another embodiment of a collapsible storage system; and

FIGS. 13a to 13d are schematic diagrams of yet a further embodiment of a collapsible storage system.

### DETAILED DESCRIPTION

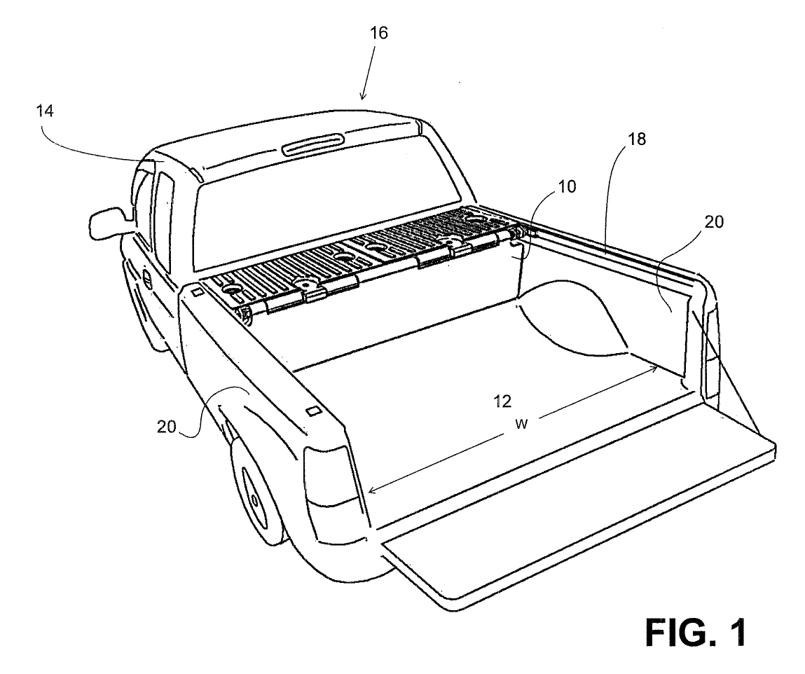

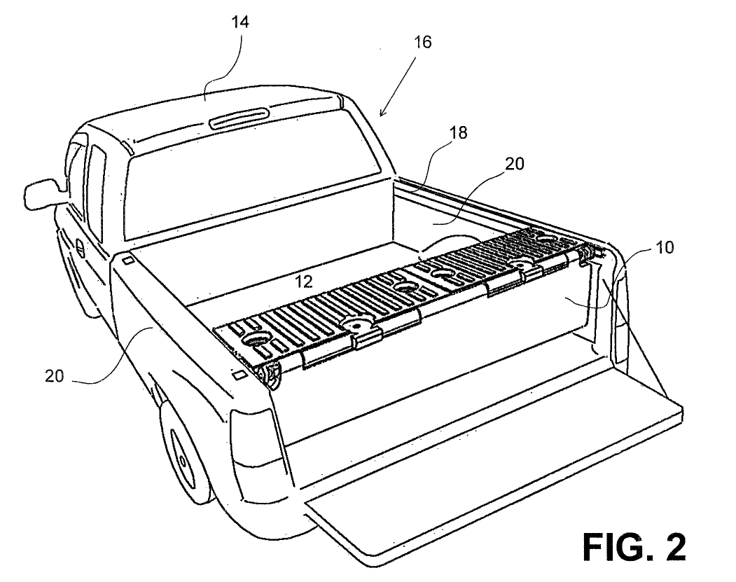

Turning to FIG. 1, a schematic view of a collapsible storage system for a vehicle storage area, such as a pickup truck bed, is shown. In the current figure, the storage system is shown in an open position. The storage system 10 is located in a front location of a truck bed 12 near the cab 14 of a vehicle such as pickup truck 16 and spans a width (w) of the bed 12. The storage system can also be located in a rear location of the bed 12 as shown in FIG. 2.

In the preferred embodiment, the storage system 10 can be moved to any desired location within the truck bed 12 by sliding the system 10 along guide rails, or tracks, 18 which are previously integrated on side walls 20 of the truck bed 12 of the truck 16.

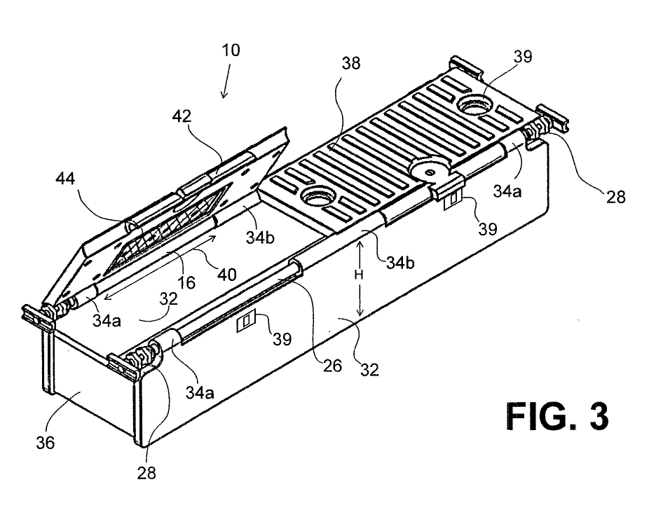

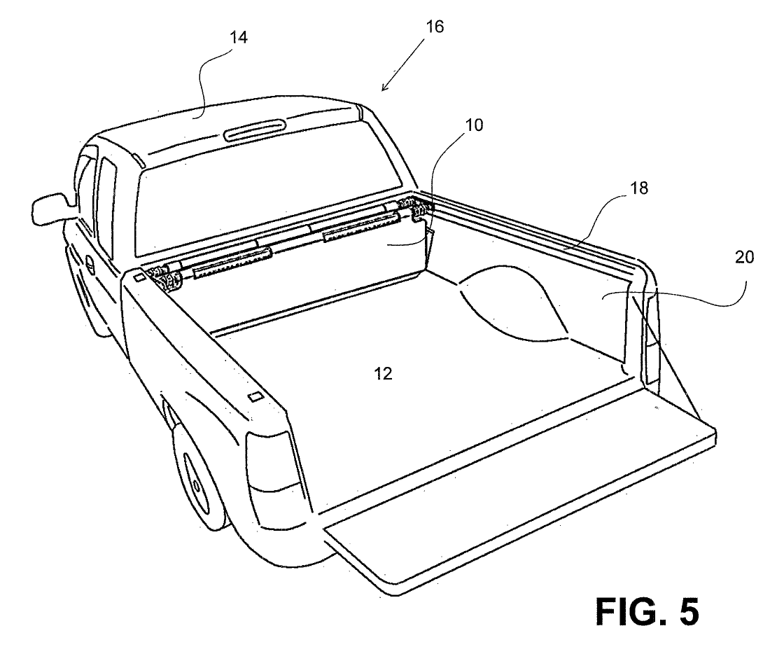

As more clearly shown in FIG. 3, the system 10 comprises a set of lateral supports, such rods, bars, tubes, or pipes and the like, 26 which span the width of the truck bed 12. At the ends of each pipe 26 is a rail integration apparatus 28 which is used to mount, or integrate, the system 10 with the rail system 18 on the truck 16. A more detailed view of the rail integration apparatus 28 is provided in FIG. 5.

The system 10 further includes a pair of panels 32, preferably plastic, which are each associated with one of the pipes 26. For the following description, the panel 32 closest to the cab 14 will be indicated as the cab, or front, panel and the panel 32 farthest away from the cab 14 will be indicated as the rear panel.

In the current embodiment, each panel 32 is connected to, or mounted to, the pipe 26 in three locations 34 (two smaller end connections 34a and one longer middle connection 34b) spanning the length of the pipe 26. These panels 32 provide a pair of relatively solid walls which serve as front and back enclosures of the storage system 10. Depending on the design of the system, the height (h) of the panels 32 is variable but is preferably the same height as the side wall 20 of the truck bed 12 or just to the tops of the wheel wells in order to install the system 10 against the vehicle's cab 14.

The panels 32 are connected to one another with a flexible but sturdy storage compartment, such as a sheet 36, preferably cloth or canvas, which is attached to the bottom and side edges of the panels 32 thereby creating a four (4) sided storage area.

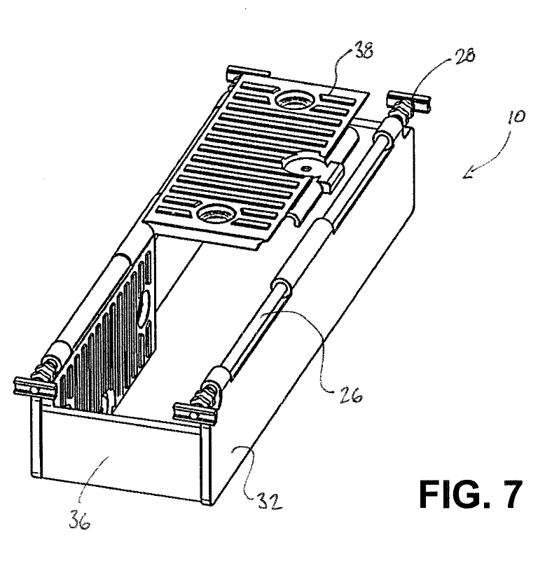

In this manner, the storage system 10 can be easily urged from the open position to a collapsed position, as will be described below with respect to FIG. 7.

In the preferred embodiment, the sheet 36 has an elastic sewed into each end on the short sides to help keep the shape of the system 10 as well as to compensate for any slack in the sheet 36 that is required to collapse the system. In an alternative embodiment, holes are punched in the bottom portion of the sheet, either by melting or with grommets, to allow liquid to drain from the storage system if something is spilled within it.

As further shown in FIG. 3, the system 10 also includes a set, preferably two, of covers 38. The covers 38 are preferably manufactured from blow-moulding plastic and are attached to one of the pipes 26, preferably the forward pipe, at locations 40 where the panel connections 34 do not cover. The covers 38 are preferably made from a sturdy material such that an individual can also sit on or rest an object on the cover 38 when the truck is parked. Cup holders 39 can also be installed in the top surface of the covers 38 and used when the system 10 is in the open position.

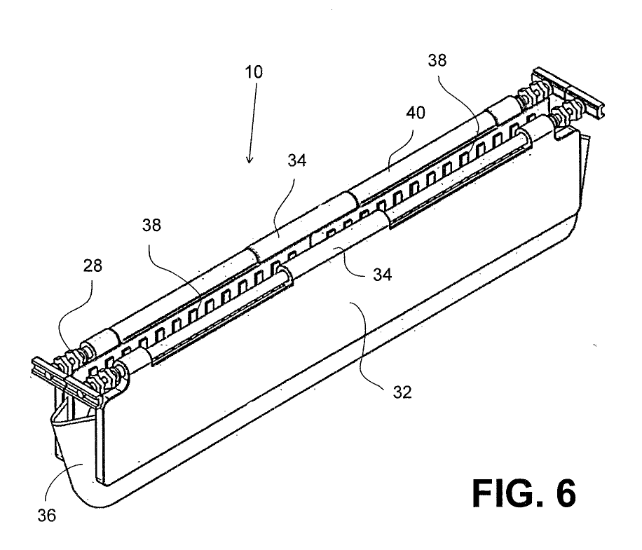

The location 40 serves as a pivot point thereby creating a hinge allowing the cover 38 to be opened to allow access to the storage area and closed to prevent access to the storage area or to restrict the content from falling out during travel. The system 10 also preferably includes a locking mechanism 41 that allows the storage area to be secured during travel when the cover is closed. In the current embodiment, the locking mechanism 41 is located on the rear panel 32. As can be seen in FIG. 6, the cover 38 includes a mating portion 42 which snaps onto the rear pipe 26 (in the closed position) where the panel locations 34 do not cover.

Nets 44 can be installed to the underside of the covers 38 to create additional storage for smaller objects.

In a preferred embodiment, a cut plastic sheet, thermoformed or blow moulded, can be placed in the bottom of the system, atop the sheet 36, to help maintain a predetermined distance between the two panels 32 and to create a solid load floor that helps to disperse the weight of the contents in the storage area to all areas of the storage system 10.

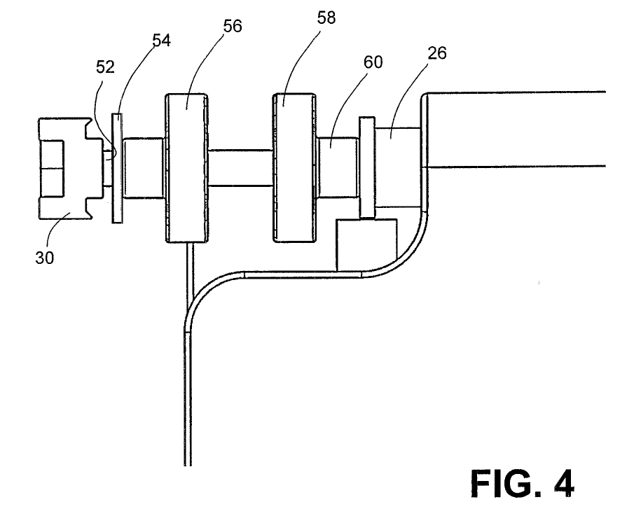

Turning to FIG. 4, an exploded view of a first embodiment of the rail integrating apparatus 28 is shown. The rail integrating apparatus 28 integrates with the existing rail system 18 so that the system 10 can be moved back and forth along the rail allowing the user to determine the required location for the system. An advantage of the current system 10 is that the system can move along the rails/track 18 without interference from the wheel wells of the truck bed 12 as the system 10 can be rotated about the pipes 26 to avoid the wheels. In this manner, the system 10 can be moved from the front of the bed to the rear of the bed and vice versa without having to detach the system 10 from the truck 16.

The rail integrating apparatus 28 is integrated to the track 18 via a track insert piece 50. A bolt 52 is inserted through the insert piece 50, a washer 54, a locking apparatus, seen in the current embodiment as a first female threaded hand-knob, or nut, 56 and a stabilizing apparatus, including a second female threaded hand-knob, or nut, 58 and a sleeve 60 which is sized to close the gap between the inside diameter of the pipe 26 and the outside diameter of the bolt 52. The rail integration apparatus is installed at the four (4) connection points, at each end of the pipes, and provides the apparatus for attaching the storage system to the truck and for the storage system to slide within the truck bed 12.

In operation, one purpose of the first hand-knob 56 is to tighten the bolt 52 to the vehicle's track 18 using the track insert piece 50 and the washer 54 to spread out the force while the second hand-knob 58 pushes up against the sleeve 60 in order to stabilize the entire system 10 on the bolt 52.

FIG. 5 provides a schematic view of the system in a collapsed position in the truck bed while FIG. 6 provides a schematic view of the system in the collapsed position. As the sheet 36 is flexible, in the collapsed position, the sheet 36 is simply folded, allowing the two panels 32 to be moved and placed adjacent to each other.

To collapse the system, the outside or first hand-knob 56 is loosened on the pipe 26 connected to the rear panel 32. The bottom thermoformed sheet (if present) is then lifted up and laid against the cab panel 32. The rear panel 32 and rail integration apparatus 28 are then pulled away from the cab 14 to the position shown in FIG. 7. This is possible because of the slack in the sheet 36, as discussed earlier.

This creates enough space for the covers 38 to swing down 90 degrees, into the storage area and rest flush with the sheet that was lifted earlier (if present). Otherwise, the covers 38 rest against the cab panel 32. Finally, the rear pipe and panel 32 are pushed toward the cab panel 32 until the rear panel is flush against the covers 38 which are now hanging vertical inside the storage area. The outside hand-knob 56 on both sides of the rear pipe are then tightened against the track 18 to keep the rear panel from further movement.

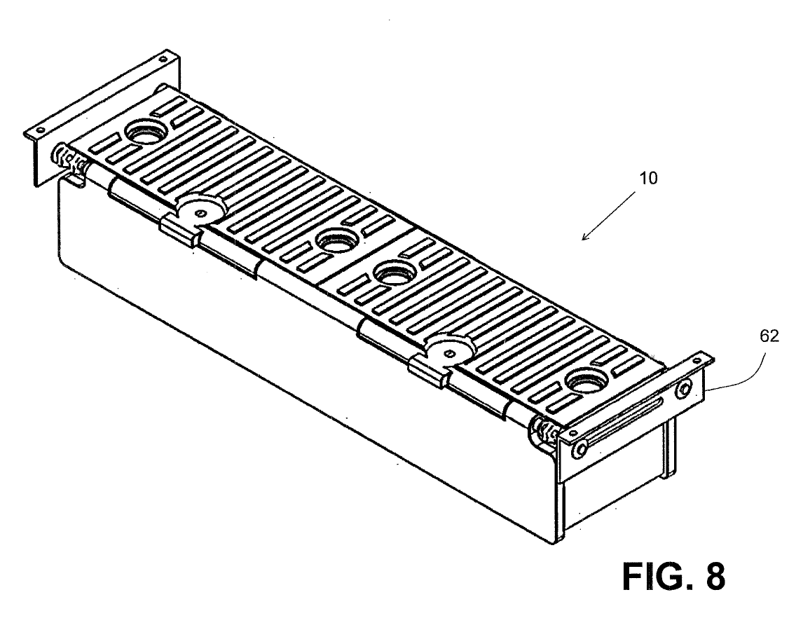

FIG. 8 is a schematic view of a collapsible storage system 10. The collapsible storage system 10 is almost identical to the storage system with the difference being a different integration apparatus for mounting the system to the truck. In this embodiment, the integration apparatus 62 is designed for trucks in which there is no existing rail or track system. The mounting system attaches directly to the body of the vehicle either under or on top of the exterior walls 20 of the truck 16.

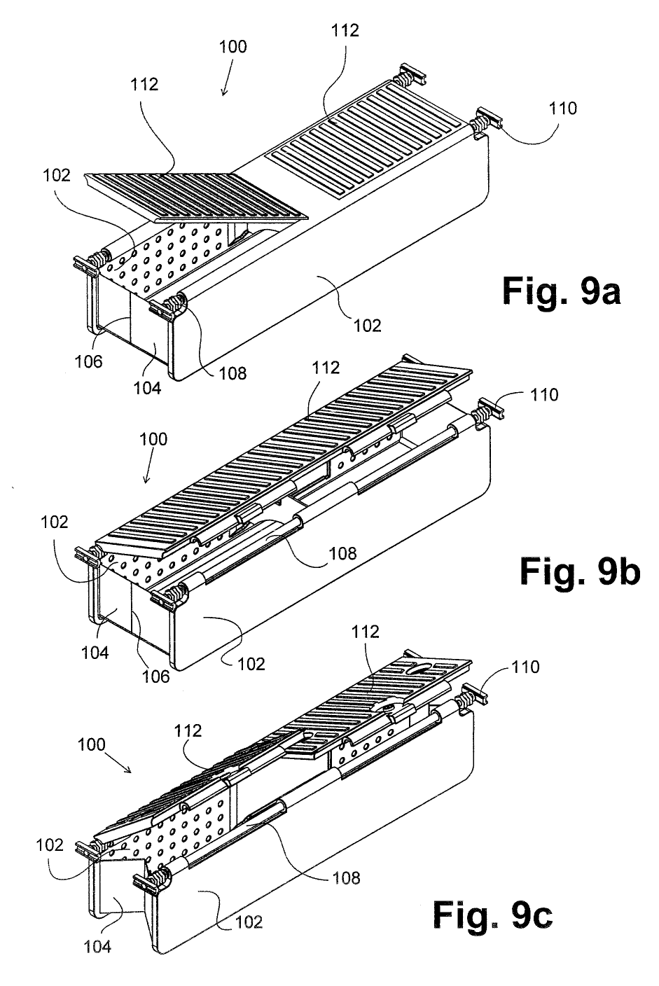

Turning to FIGS. 9a to 9c, perspective views of further embodiments of a storage system is shown. In each of these embodiments, the storage system 100 includes a pair of panels 102 acting as front and rear walls to the system 100. Semi-rigid portions 104 are provide as side walls with each portion 104 including a crease line 106 so that the system is collapsible in order to move the system between the open position and closed positions. Each system 100 further includes a pair of pipes 108 having integration apparatus 110 located at each end of the pipes to mount the system 100 to the vehicle.

Each of the embodiments includes a different style of cover 112, however the functionality and parts are basically the same in each embodiment.

In FIG. 9c, the system 100 is shown in a semi-collapsed state.

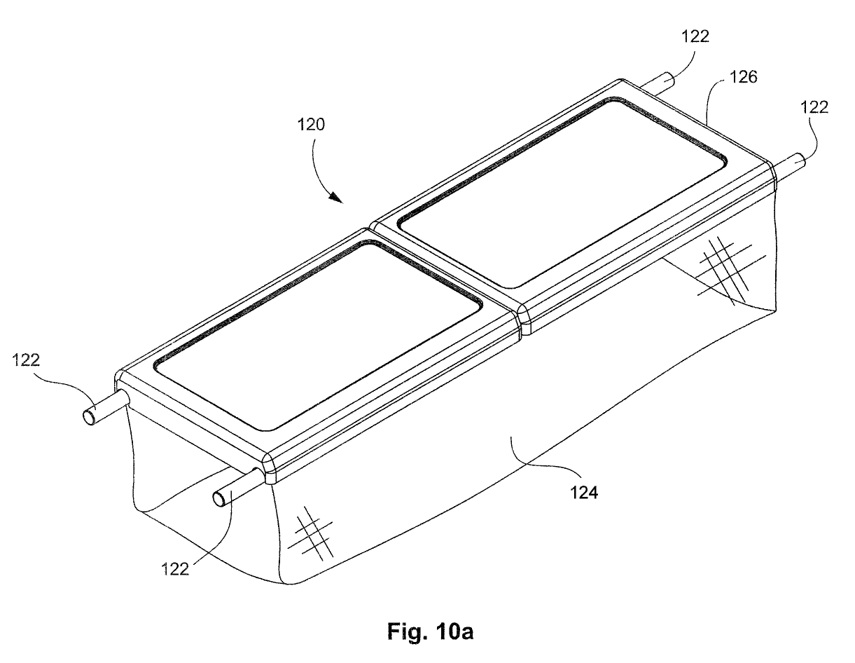

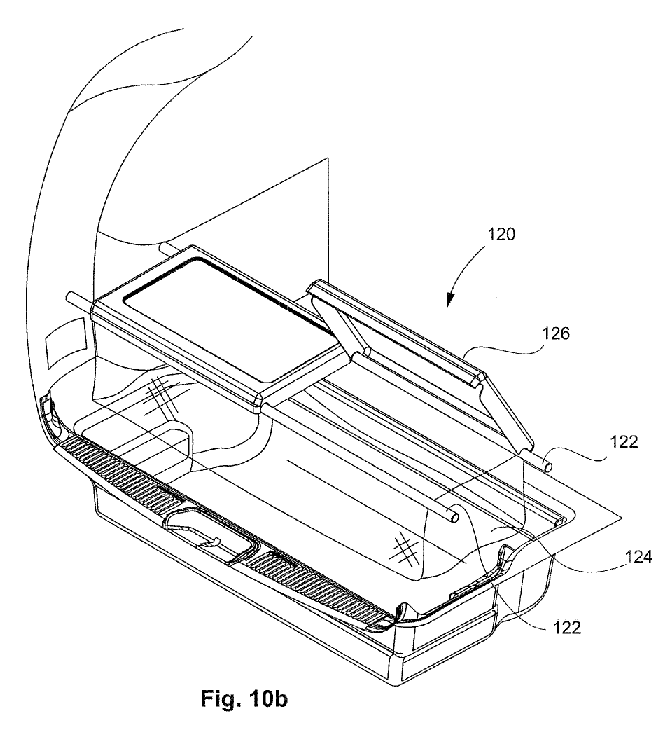

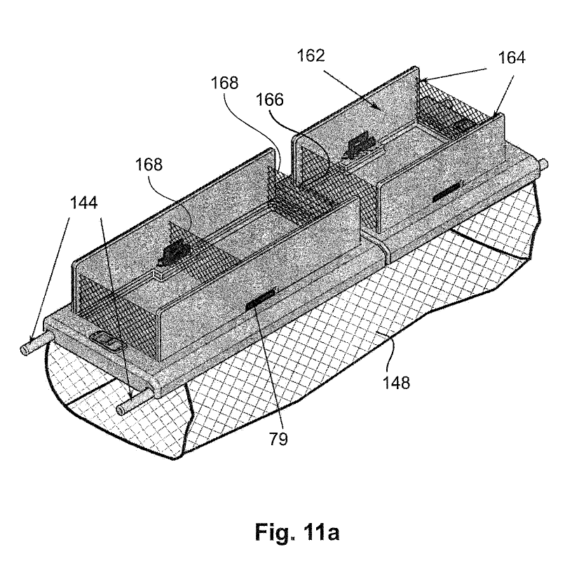

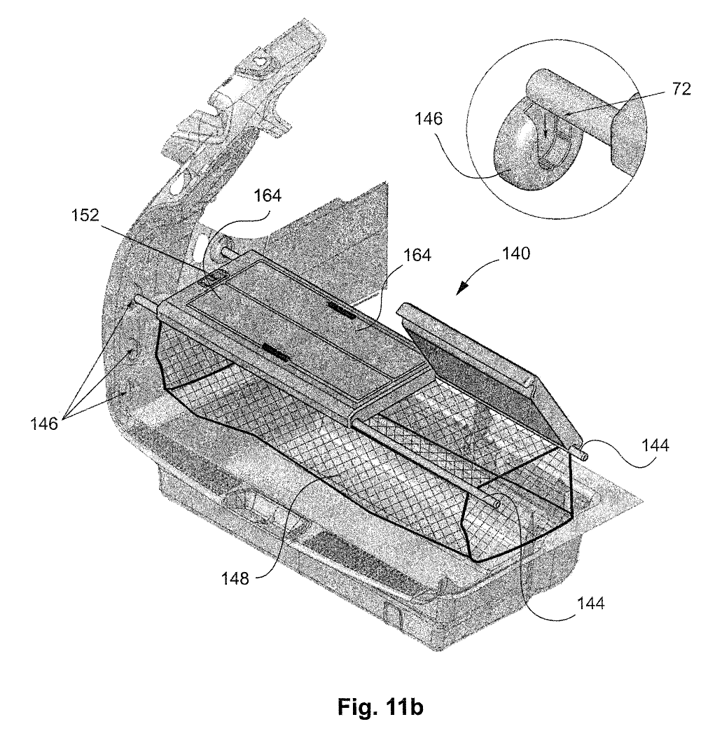

Turning to FIGS. 10a, 10b, 11a and 11b, embodiments illustrating the storage system installed within a van are shown.

As shown in FIGS. 10a and 10b, the storage system 120 includes a pair of pipes 122, or load bars, which span a width of the rear of the vehicle and are mounted at each end to the sides of the van. In this embodiment, the ends are mounted along a rail so that the pipes can be slid back and forth in order to open and close the storage system 120. The storage system 120 includes a storage area defined by the netting 124 attached to the pipes 122. The netting 124 provides a flexible storage area and is capable of being collapsed when the storage system 120 is not in use. Covers 126 are pivotable about one of the pipes 122 and are used to enclose the storage area so that the contents are unable to fall out during travel.

As shown in FIGS. 11a and 11b, a second embodiment of a collapsible storage system for a van is shown. The storage system 140 includes a pair of pipes, or load bars, 144 which are held in place by a vehicle interface 146. The van preferably includes a plurality of vehicle interfaces 146 so that the user can determine the height level at which the storage system 140 is located. In these embodiments, the walls of the storage system are preferably provided by a single net 148 which is collapsible when required. A set of covers 150 is provided over the nets 148 to protect the contents from falling during transportation.

The system of FIGS. 11a and 11b further includes an extra storage system 162 located on the covers 150 of the system 140. In this embodiment, the extra storage area is locked by a release hatch 152. When the user wishes to access the extra storage area 162, after disengaging the release hatch 152, a handle 153 is used to pull up a pair of side walls 164.

The extra storage area is defined at two ends by the pair of walls 164. As shown in FIG. 11a, the walls 164 are located within the covers 150 and open up vertically (from a horizontal position) to provide the extra storage space 162. Further side walls 166 are preferably provided via dividers 168, seen as flexible nets.

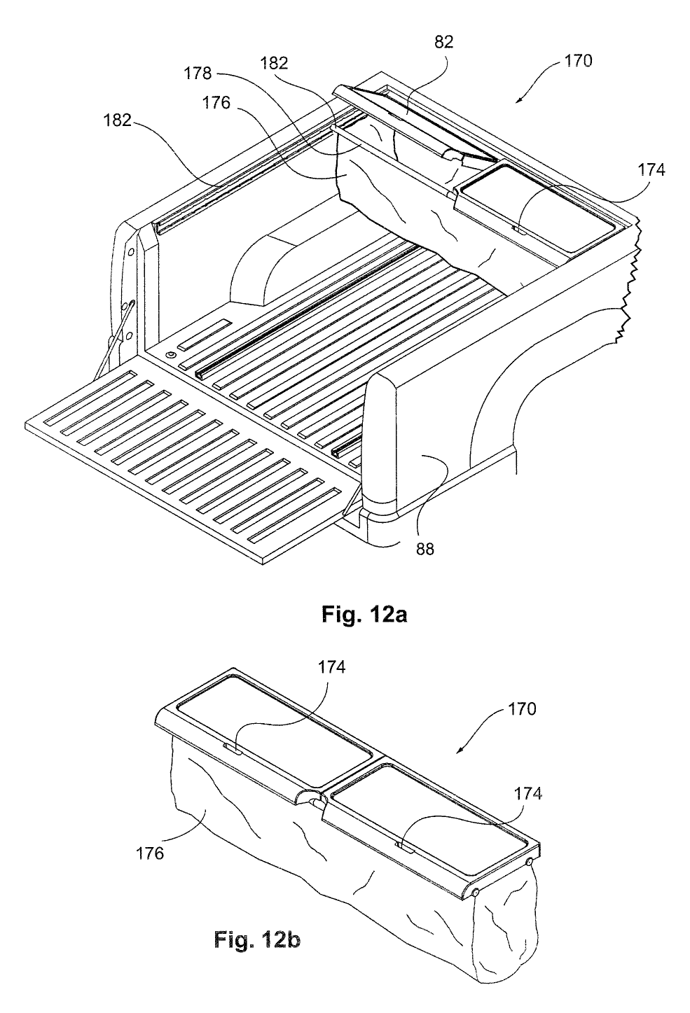

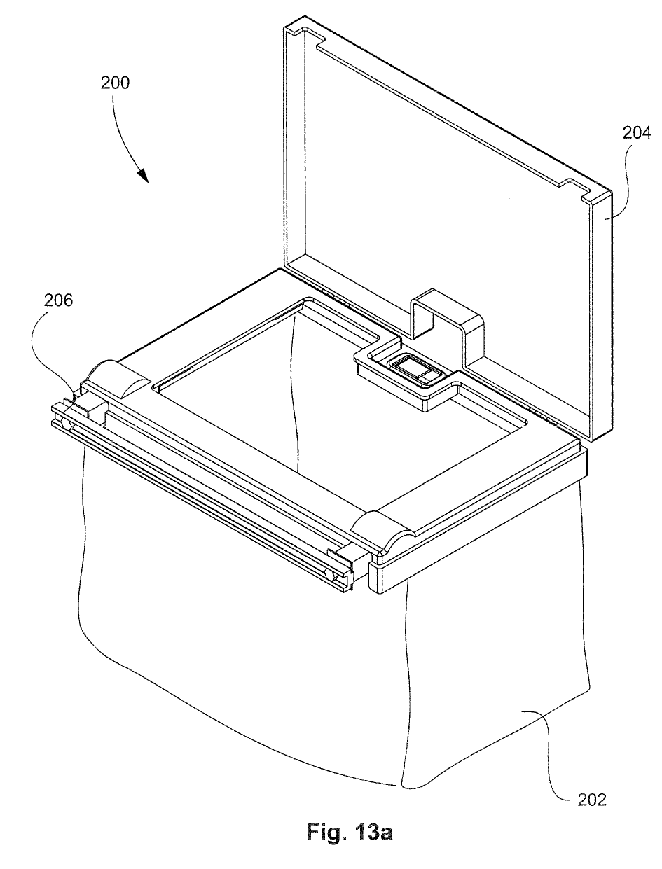

Turning to FIGS. 12a and 12b, yet a further embodiment of a storage system for a truck is shown. The system 170 includes a set of covers 172, each of the covers including a handle 174 in order to make it easier for a user to access the contents of the storage system 170. The storage system 170 further comprises a bag 176, serving as the storage area or the walls of the storage area that is preferably manufactured from a weather/UV resistant material.

As with the previous embodiment, the system 170 also includes a pair of poles, or pipes, 178 which are mounted to rails or tracks 180 within a truck using an integration apparatus 182. In an alternative embodiment, an optional attachment system, or integration apparatus, can also be included with the system 10 for installation in vehicles that do not have an integrated track system. In one alternate embodiment, the optional system includes a metallic plate, hard mounted to the vehicle's bed wall, with a hole drilled in one end to accept the stationary bolt for the pipe closest to the vehicle's cab or the forward end and a slot at the other end to accept the sliding pipe necessary to make the system collapsible.

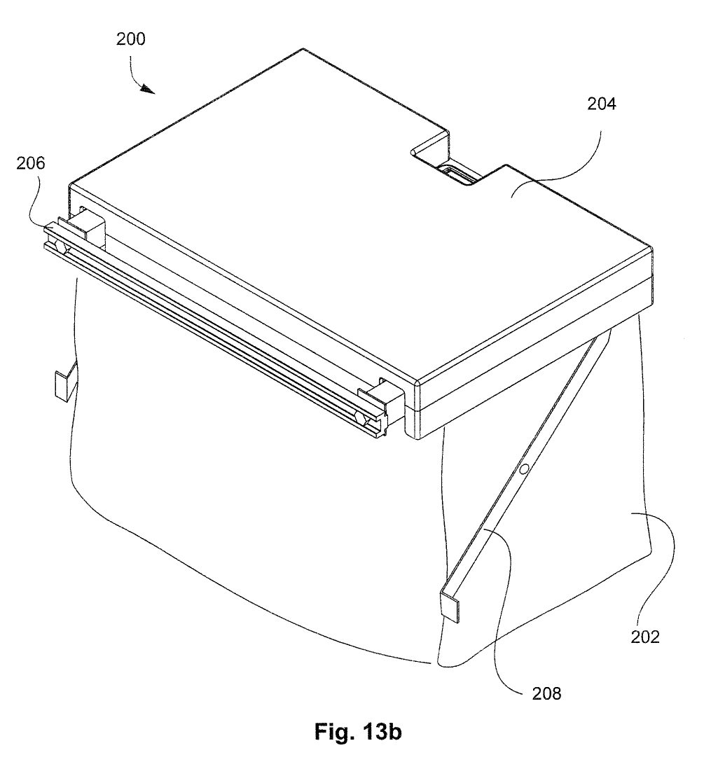

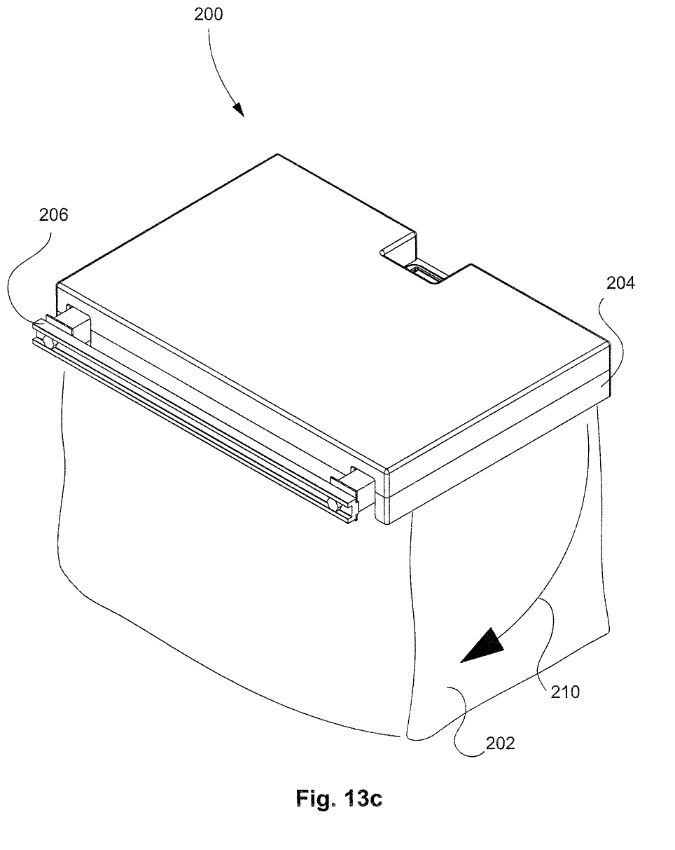

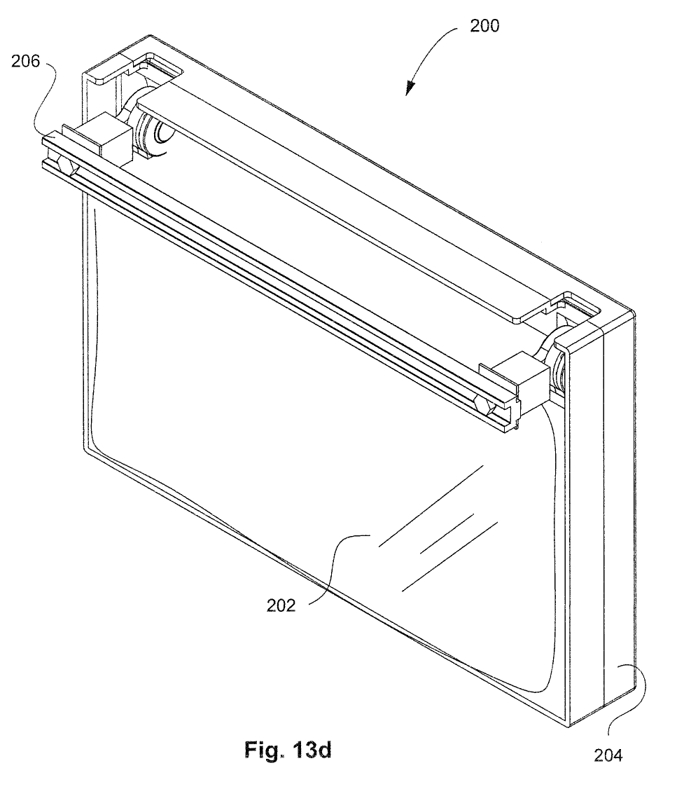

Turning to FIGS. 13a to 13d, yet a further embodiment of a collapsible storage system is shown. FIG. 13a shows the storage system 200 in an open position. The collapsible storage system 200 includes a storage area 202, which is seen as a flexible bag. The storage area, or compartment, 202 is enclosed by a cover 204 which serves to keep the contents inside the storage system 200 during transportation. The cover 204 preferably includes a locking mechanism so that the contents of the storage system 200 can be protected from theft.

The storage system 200 also includes a truck integration apparatus 206 which allows the storage system to be mounted to a wall 20 of the truck 16. In this embodiment, the storage system is mounted in a front to back direction within the truck bed and collapses parallel to the wall of the truck. As shown in FIG. 13b, the cover 204 is preferably cantilevered, via beam 208, with respect to the truck wall. In order to collapse the system 200, the beam 208 is moved so that it is located under the cover 204 and the cover 204 is moved towards the wall of the truck, in the direction of arrow 210 (FIG. 13c).

As shown in FIG. 13d, in the collapsed position, the cover 204 is parallel to the bag 202 and rests against the wall of the truck (not shown) in order to minimize the space required to store the storage system when not in use.

In an alternative embodiment, the system further includes apparatus for securing the system to the vehicle when the system is in either the open and/or closed positions so that the system does not move about in the vehicle while the vehicle is in motion.

Preferred and exemplary embodiments of this invention are described herein. Variations of those embodiments can become apparent to those of ordinary skill in the art upon reading the foregoing description. It is expected that skilled persons will employ such variations as appropriate, and it is expected that the invention can be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Without limiting the generality of the foregoing statement, some specific examples of possible variations can include the following, though others can be apparent to those knowledgeable in the field of the invention.

Further variations can be apparent or become apparent to those knowledgeable in the field of the invention, and are within the scope of the invention as defined by the claims which follow.

1. A collapsible storage system for a storage area of a vehicle comprising:
a pair of panels;
a flexible sheet, connecting said pair of panels;
wherein said panels can be moved between open and collapsed positions by extending and folding the sheet respectively.

2. The collapsible storage system of claim 1 wherein the vehicle is a pickup truck.

3. The collapsible storage system of claim 2 wherein the storage area is a pickup truck bed.

4. The collapsible storage system of claim 3 further comprising:
a pair of lateral supports, extending a width of the pickup truck; and
an integration apparatus, mounted on each end of the pair of lateral supports, for mounting the storage system to the pickup truck;
wherein each one of the pair of panels is attached to one of the pair of lateral supports.

5. The collapsible storage system of claim 4 wherein the integration apparatus is a rail integration apparatus for mounting with an existing rail system within the pickup truck.

6. The collapsible storage system of claim 5 wherein the rail integration apparatus comprises:
a track insert piece for insertion in the existing rail system;
a bolt, located within the track insert piece; and
a locking apparatus, attached to the bolt, for locking the storage system to the rail system.

7. The collapsible storage system of claim 6 wherein the rail integration apparatus further comprises a stabilizing apparatus for stabilizing the storage system within the truck.

8. The collapsible storage system of claim 6 wherein the locking apparatus is released, the lateral supports are able to be moved in order to move the storage system between the open and closed positions.

9. The collapsible storage system of claim 7 wherein the stabilizing apparatus comprises:
a sleeve, located around the bolt; and
a threaded hand-knob;
wherein the hand-knob is tightened to push the sleeve against the bolt to stabilize the system.

10. The collapsible storage system of claim 4 further comprising a set of covers for protecting the contents of the storage system.

11. The collapsible storage system of claim 10 wherein the cover comprises cup holders.

12. The collapsible storage system of claim 1 further including nets for defining separate storage locations within the storage system.

13. The collapsible storage system of claim 1 wherein the flexible sheet is made from cloth or canvas.

14. A collapsible storage system for a storage area of a vehicle comprising:
a pair of panels;
a foldable sheet, connecting said pair of panels;
wherein said panels can be moved between open and collapsed positions by extending and folding the sheet respectively.

15. The storage system of claim 2 wherein the panels are moved in a direction which is parallel to a cab of the pick up truck.

16. The storage system of claim 2 wherein the panels are moved in a direction which is perpendicular to a cab of the pickup truck.

17. A collapsible storage system comprising:
a truck integration apparatus;
a cover;
a flexible storage compartment, located under the cover;
a support structure, connected to the truck integration apparatus and for supporting the cover;
wherein the cover can be pivoted about the support structure between open and closed positions.

18. The collapsible storage system of claim 17 wherein the system is collapsible about the truck integration apparatus.
